(19) United States
(12) Patent Application Publication
(10) Pub. No.: US 2005/0066760 A1
(43) Pub. Date: Mar. 31, 2005

(54) Column shifter with impact absorbing structure

(76) Inventor: Yoshihiro Takikawa, Hoi-gun (JP)

Correspondence Address: JOHN S. PRATT, ESQ;KILPATRICK STOCKTON, LLP, 1100 PEACHTREE STREET, ATLANTA, GA, 30309, US

(21) Appl. No.: 10/953,628

(22) Filed: Sep. 29, 2004

(30) Foreign Application Priority Data
Sep. 30, 2003 (JP) P2003-342381

(51) Int. Cl. B60K 20/00; B62D 1/19

(52) U.S. Cl. 74/473.31

(57) ABSTRACT

A column shifter has an impact absorbing structure. The column shifter includes a shift lever rotatably supported to a steering column. The column shifter includes a bellcrank supported to the steering column and being rotatable by the shift lever about the rotation center to operate a transmission. The bellcrank includes a first link angularly-displaced by the shift lever. The bellcrank includes a second link separated angularly from the first link about the rotation center. The second link includes a distal end connected to the transmission. The second link includes a strength weakened portion between the distal end and the rotation center.

### CROSS-REFERENCE TO RELATED APPLICATIONS

This application is based upon and claims the benefit of priority from Japanese Patent Application No. 2003-342381 filed on Sep. 30, 2004; the entire contents of which are incorporated herein by reference.

### BACKGROUND OF THE INVENTION

The present invention relates to a column shifter with an impact absorbing structure having an impact absorbing function for a driver.

A column shifter includes a steering column on which a shifter of a transmission is mounted, and widely and advantageously secures a space around a driver's seat. The shifter is formed of various parts, and the parts are disposed around the steering column. When a head-on collision of a vehicle occurs, driver's knees collide against these various parts. This is called a secondary collision.

The impact absorbing structure at a secondary collision is disclosed in Patent Literature 1 (Japanese Patent Application Laid-Open No. 2000-177602). This structure has an operating mechanism which is operated by a shift lever. The operating mechanism is fixed to the steering column. Both the steering column and the operating mechanism are covered with a column cover which includes an impact absorbing metal plate disposed on the front side of the vehicle. This plate is fixed to the steering column or the operating mechanism.

According to this structure, driver's knees collide against the metal plate at the time of a secondary collision to plastically deform the metal plate, thereby absorbing an impact.

### SUMMARY OF THE INVENTION

When the metal plate is plastically deformed, the impact absorbing structure requires a space so that the impact absorbing structure moves forward of the vehicle. This structure is increased in size by a size of the column cover provided in the space for covering the metal plate. If this impact absorbing structure is employed, a large space is required around the knees of a driver, and this is inferior in terms of general versatility.

The present invention is directed to a column shifter with an impact absorbing structure that reduces impact acting on the knees at a secondary collision even if a vehicle has a narrow space around the driver's knees.

The aspect of the invention provides a column shifter with an impact absorbing structure. The column shifter includes a shift lever rotatably supported to a steering column. The column shifter includes a bellcrank supported to the steering column and being rotatable by the shift lever about the rotation center to operate a transmission. The bellcrank includes a first link angularly displaced by the shift lever. The bellcrank includes a second link separated angularly from the first link about the rotation center. The second link includes a distal end connected to the transmission. The second link includes a strength weakened portion between the distal end and the rotation center.

The strength weakened portion may be thinned.

The distal end may have a check plate fixed thereto. The steering column includes a check block projecting downwardly of a vehicle body. The check block has a ratchet concavo-convex part to be engaged with the check plate at rotation positions of the bellcrank in correspondence with shift positions of the shift lever. The check block receives a collision from rear to front of the vehicle body to disengage from the steering column.

The check block may be fixed to the steering column using a screw. The check block has a U-shaped insertion hole for the screw to fix the steering column to the check block. The insertion hole is opened toward rear of the vehicle body.

The column shifter may include a cam mechanism. The cam mechanism includes a cam defined by the first link. The cam includes a cam follower rotatable with the shift lever for traveling along the cam to rotate the bellcrank.

The strength weakened portion may be narrowed.

The strength weakened portion may be holed through the bellcrank.

According to the aspect, collision of a vehicle at the front allows a passenger to be moved forwardly of a vehicle body. The passenger's knee secondarily collides against the distal end of the bellcrank, with the distal end projecting downwardly. The secondary collision breaks the bellrank at the strength weakened portion, which moves the downward distal end forwardly of the vehicle body. This reduces collision acting on the knee at the secondary collision. Without using a special component to absorb impact at the collision, the bellcrank, necessary for the column shifter, is devised to absorb impact. This prevents enlargement of a column cover covering the column shifter, and allows impact absorption at the collision, even if the vehicle has a narrow space around the passenger's knee.

The passenger's knee secondarily collides against the distal end to break the thinned portion, reducing impact acting on the knee. Adjustment of the thinned portion in thickness facilitates setting of breaking load. This secures impact absorption.

When the passenger's knee secondarily collides against the check block, the check block moves with the distal end of the bellcrank forwardly of the vehicle body relative to the steering column, disengaging from the steering column. This reduces impact acting on the knee.

When the passenger's knee secondarily collides against the check block, the check block moves forwardly of the vehicle body relative to the steering column in a direction of disengaging from the screw, disengaging from the steering column. This secures impact absorption.

### BRIEF DESCRIPTION OF THE DRAWINGS

FIG. 1 is a side view of a column shifter having an impact absorbing structure according to an embodiment of the present invention, wherein an arrow F represents a forward direction of a vehicle;

FIG. 2 is an enlarged view around the column shifter illustrated in FIG. 1;

FIG. 3 is an enlarged perspective view of a bellcrank and a connecting part on the side of a shift lever of the column shifter illustrated in FIG. 1;

FIG. 4A is a sectional view of a strength weakened portion taken along IVA-IVA in FIG. 3;

FIG. 4B is a sectional view of another strength weakened portion in correspondence with FIG. 4A;

FIG. 4C is a sectional view of another strength weakened portion in correspondence with FIG. 4A;

FIG. 5 is a rear view of an essential portion of the column shifter illustrated in FIG. 2; and

FIG. 6 is an exploded perspective view illustrating vertically reversed column shifter illustrated in FIG. 2, with a check block and a check plate mounted to each other, corresponding to a diagram of the vertically reversed steering column 5 illustrated in FIG. 2 as viewed from below the vehicle.

### DETAILED DESCRIPTION OF THE PREFERRED EMBODIMENTS

The following describes embodiments of the present invention with reference to the accompanying drawings.

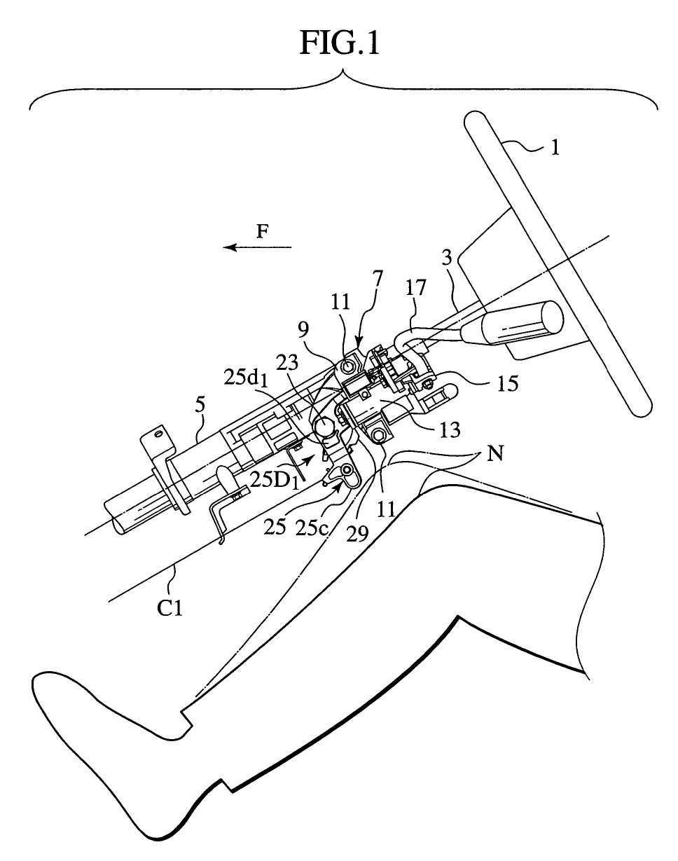

With reference to FIG. 1, a steering includes a steering wheel 1 which is connected to a steering shaft 3. The steering includes a cylindrical steering column 5 which is rotatably inserted into the steering shaft 3. The steering column 5 includes a column shifter 7 mounted on a side of the steering column 5.

The steering column 5 and the column shifter 7 are covered by a column cover (not shown). The column cover is deformed when knees of a driver collide against the cover, thereby absorbing an impact.

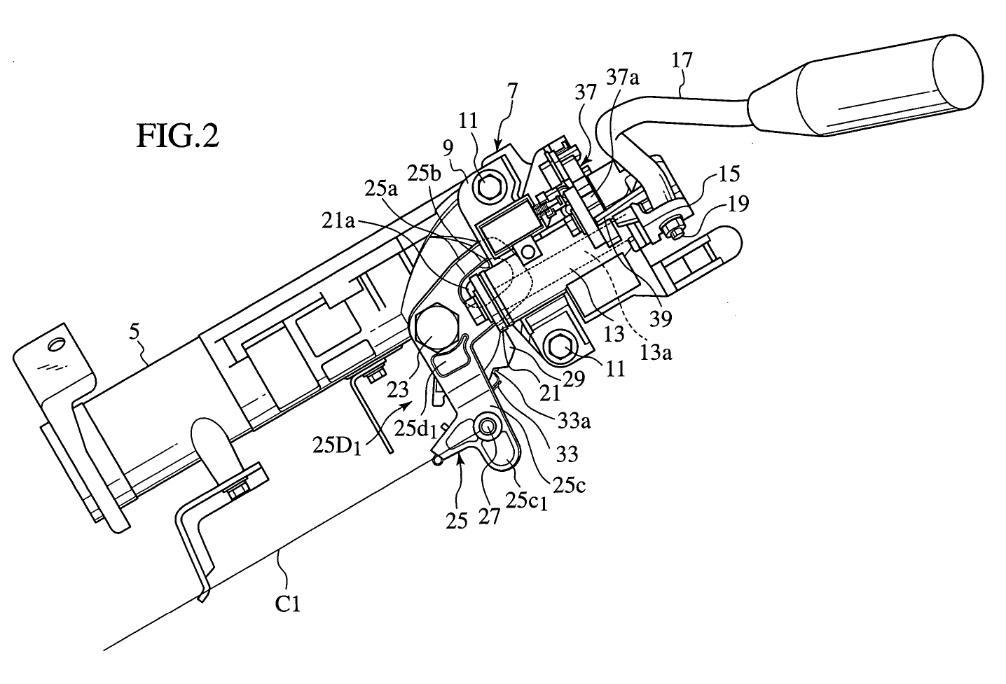

With reference to FIG. 2, the column shifter 7 includes a lever bracket 9 fixed to the steering column 5 through two bolts 11. The lever bracket 9 includes a cylindrical portion 13 having a rod 13a which is in parallel to the steering shaft 3. The rod 13a is rotatably inserted into the cylindrical portion 13. The rod 13a has an end closer to the steering wheel 1, the end being fixed to the bracket 15. The bracket 15 is rotatably mounted on a shift lever 17 using a rotation support pin 19 which extends in a direction perpendicular to the rod 13a.

The rod 13a has the opposite end located on opposite side from the bracket 15 of the cylindrical portion 13, the opposite end being fixed to a connecting arm 21 as a cam follower.

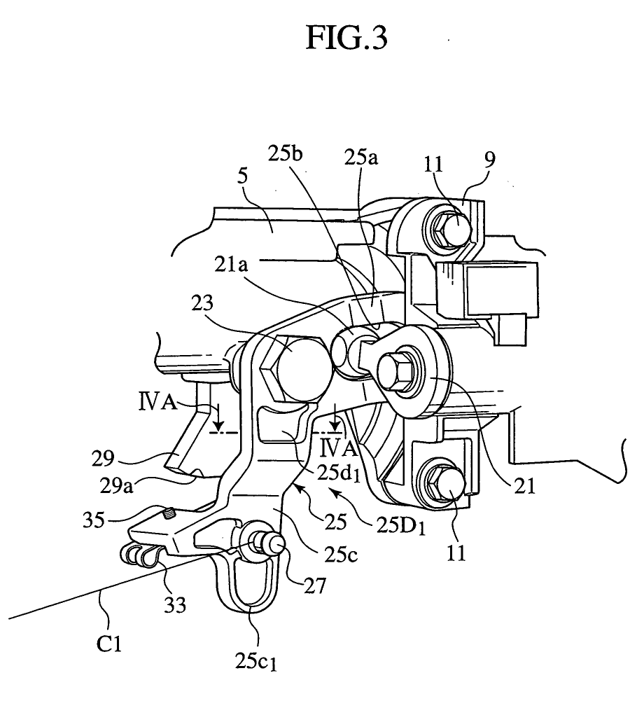

The steering column 5 has a side located closer to a front portion of the vehicle than the lever bracket 9. The side is mounted on a bellcrank 25 made of aluminum alloy. The bellcrank 25 rotates around a support bolt 23 as the rotation center in association with the shift lever 17. The bellcrank 25 has a first link 25a with an distal end that extends toward the shift lever 17. The first link 25a defines an elongated engagement hole 25b as a cam. As illustrated in FIG. 3, the engagement hole 25b is movably engaged with a connecting part 21a provided on the end of the connecting arm 21.

The bellcrank 25 has a second link 25c with a distal end 25C1 that extends toward the bottom of the vehicle. The distal end 25c1 has a pin 27 connected to a shift cable C1. The end of a shift cable C1 is connected to a transmission (not shown). The opposite end of the shift cable C1 is connected to the pin 27.

The shift lever 17 rotates the rod 13a by shifting operation. This rotation allows for rotation of the connecting arm 21. The connecting part 21a angularly displaces the bellcrank 25 while moving in the engagement hole 25b in the radial direction. This displacement rotates the bellcrank 25 about the support bolt 23. The rotation of the bellcrank 25 displaces the shift cable C1 in the longitudinal direction, and this displacement operates the transmission.

The second link 25c of the bellcrank 25 requires a predetermined length to ensure an operation stroke of the shift cable C1 connected to the bellcrank 25. For this reason, the second link 25c needs to extend toward the bottom of the vehicle as compared with other parts of the column shifter 7.

The bellcrank 25 includes a strength weakened portion 25D1 having a U-shaped thinned portion 25d1 between the support bolt 23 as the rotation center and the distal end 25c1, and close to the support bolt 23. The thinned portion 25d1 is thinner than the other portions of the bellcrank 25. When knees N of a driver shown in FIG. 1 give a secondary collision against the distal end 25c1 of the second link 25c, the secondary collision breaks the thinned portion 25d1. The break allows the distal end 25c1 to be moved, thus reducing impact acting on the knees N of the driver.

The strength weakened portion 25D1 has characteristic in strength that is established by the transverse section with a certain area and a certain shape. The transverse section is reduced by 20% to 40% in area from the original section. The strength weakened portion 25D1 is set to bear a static load to 1470 N in view of a pushing or pulling load of 392 N to be applied to the shift lever 17. The strength weakened portion 25D1 is set to break under a dynamic load of 2450 N that is an impact stress by the knee.

The thinned portion 25d1 may be shaped into a triangle, a rectangle, a polygon, a circle or another configuration. The thinned portion may be separated into portions. The bellcrank 25 may be thinned from both sides into an H-shaped section.

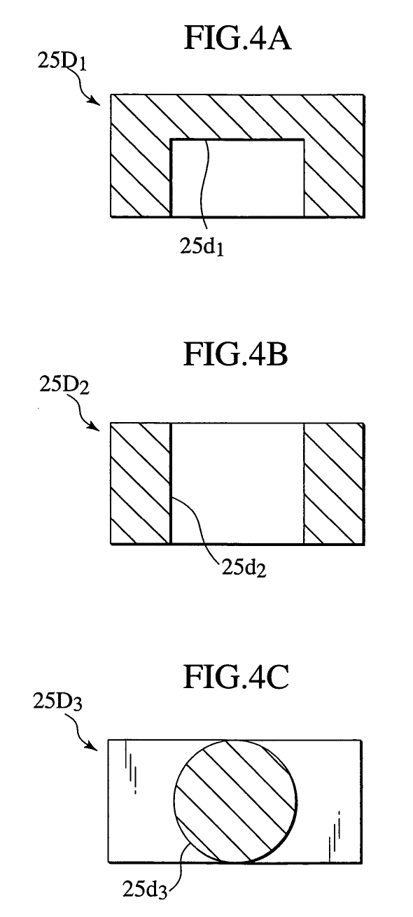

In FIG. 4B, another strength weakened portion 25D2 includes a hole 25d2 through the bellcrank 25 in a direction of thickness.

In FIG. 4C, another strength weakened portion 25D3 includes a transversely narrowed portion 25d3 in a circular section. The narrowed portion 25d3 may be shaped in a triangular, rectangular or polygonal section.

Another strength weakened portion may be made of a material smaller in strength than aluminum alloy in the bellcrank 25.

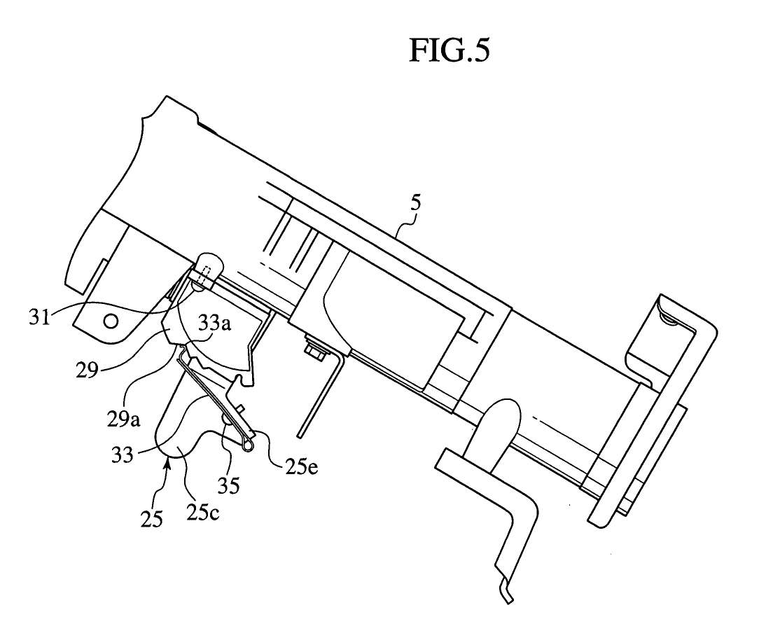

The bellcrank 25 has the steering column 5 located adjacent thereto. The steering column 5 has a lower portion fixed to a synthetic resin check block 29 by a screw 31 as illustrated in FIG. 5. The check block 29 is provided at the outer peripheral surface of the lower portion in FIG. 5, with a ratchet concavo-convex portion 29a (concavo-convex portion, hereinafter).

The bellcrank 25 has a check plate mounting part 25e on the side opposite to the pin 27. The mounting part 25e projects in an upward direction perpendicular to a sheet of FIG. 5. The mounting part 25e is mounted by a screw 35 and a check plate 33 of a leaf spring with a prescribed axial force.

The check plate 33 includes a base end fixed by a screw 35, and the check plate 33 extends from the base end toward the steering wheel 1. The check plate 33 includes a tip end 33a which is bent toward the concavo-convex portion 29a of the check block 29, and is resiliently pushed against the concavo-convex portion 29a. In this state, the tip end 33a enters a predetermined portion of the concavo-convex portion 29a at each shift position when the shifting operation of the shift lever 17 is carried out. This structure provides a user or a driver with a ratchet feeling when the shifting operation is carried out, that is, the user or the driver can reliably physically sense the shifting operation of each shift position in a ratchet manner.

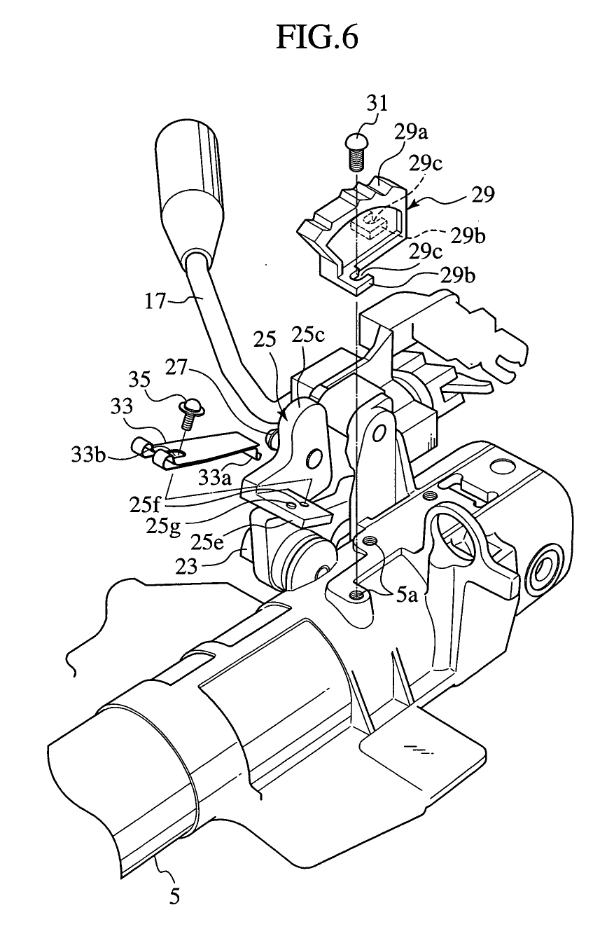

With reference to FIG. 6, the check block 29 includes two mounting parts 29b located on the opposite side from the concavo-convex portion 29a. The mounting parts 29b are located on the opposite side surfaces of the check block 29, with one of the mounting parts 29b being located on the front side of the vehicle and the other one being located on the rear side of the vehicle.

Each of the mounting parts 29b includes a U-shaped screw-insertion hole 29c which is opened toward the rear side of the vehicle where a driver exists. The screws 31 are inserted into the screw-insertion holes 29c. The screws 31 are threadedly inserted into two screw holes 5a of the steering column 5, thereby fixing the check block 29 to the steering column 5.

The check plate 33 includes a U-shaped screw-insertion hole 33b which is opened toward the opposite side from the screw-insertion hole 29c, that is, toward the front side of the vehicle opposite from a driver. The screw-insertion hole 33b has a screw 35 inserted thereinto. The screw 35 fixes the check plate 33 to the bellcrank 25 utilizing a screw hole 25f formed in the check plate mounting part 25e of the bellcrank 25. The check plate mounting part 25e includes a positioning protrusion 25g. The insertion of the positioning protrusion 25g into the screw-insertion hole 33b allows rotation of the check plate 33 about the screw 35 to be limited.

As illustrated in FIG. 2, the steering column 5 has an end closer to the shift lever 17. The end is mounted on a position plate 37 to set the shift position. The position plate 37 is provided at the outer peripheral surface with a detent 37a. The detent 37a includes unevenness in correspondence with P, R, N, D, and L which are the shift positions of the shift lever 17.

The shift lever 17 has a base end having a detent pin 39 in engagement with the detent 37a. The shift lever 17 is pivoted about the rotation support pin 19 to approach toward a driver. The pivot separates the detent pin 39 from the detent 37a. When the shift lever 17 is turned around the rod 13a in this state, the detent pin 39 comes into coincidence with a predetermined shift position of the detent 37a. Then, the shift lever 17 is pivoted about the rotation support pin 19 to move away from the driver. This allows the detent pin 39 into engagement with the detent 37a.

The following describes the operation of the impact absorbing structure of the column shifter. When the shift position is in a D range which is used at the time of normal driving, as illustrated in FIG. 1, the second link 25c of the bellcrank 25 extends toward the bottom of the vehicle substantially perpendicular to the steering column 5.

In this state, the vehicle collides in a head-on manner, which allows a driver to be moved in a forward direction of the vehicle. This head-on collision moves knees N of the driver in the same direction. The movement allows the knees N to provide the secondary collision against the distal end 25c1 of the bellcrank 25. The secondary collision breaks the bellcrank 25 at the thinned portion 25d1, allowing the distal end 25c1 to be moved forward. Thus, the movement reduces an impact which acts on the knees N at the secondary collision.

The screw-insertion hole 29c of the check block 29 is formed into a U-shape which is opened toward a driver. When the knees N provides the secondary collision against the check block 29 adjacent to the bellcrank 25, the check block 29 moves forward of the vehicle with respect to the steering column 5 in a direction in which the check block 29 comes out from the screw 31, thereby reducing the impact.

The bellcrank 25 may be mounted separatably from the steering column 5 at the time of the secondary collision like the check block 29, thereby absorbing the impact.

This impact absorbing structure does not use any special parts for absorbing an impact caused at the time of the secondary collision, and an impact is absorbed by devising the bellcrank 25 and the check block 29 as the column shifter 7. This prevents size enlargement of the column cover which covers a portion of the column shifter 7 closer to a driver. This structure absorbs an impact caused at the secondary collision, with a vehicle having a small space around the knees N of the driver.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

1. A column shifter with an impact absorbing structure comprising:
a shift lever rotatably supported to a steering column; and
a bellcrank supported to the steering column and being rotatable by the shift lever about the rotation center to operate a transmission,
the bellcrank comprising:
a first link angularly displaced by the shift lever; and
a second link separated angularly from the first link about the rotation center;
the second link comprising:
a distal end connected to the transmission; and
a strength weakened portion between the distal end and the rotation center.

2. A column shifter according to claim 1,
wherein the strength weakened portion is thinned.

3. A column shifter according to claim 1,
wherein the distal end has a check plate fixed thereto,
wherein the steering column includes a check block projecting downwardly of a vehicle body,
wherein the check block has a ratchet concavo-convex part to be engaged with the check plate at rotation positions of the bellcrank in correspondence with shift positions of the shift lever,
wherein the check block receives a collision from rear to front of the vehicle body to disengage from the steering column.

4. A column shifter according to claim 3,
wherein the check block is fixed to the steering column using a screw,
wherein the check block has a U-shaped insertion hole for the screw to fix the steering column to the check block,
wherein the insertion hole is opened toward rear of the vehicle body.

5. A column shifter according to claim 1, further comprising:
a cam mechanism comprising:
a cam defined by the first link; and
a cam follower rotatable with the shift lever for traveling along the cam to rotate the bellcrank.

6. A column shifter according to claim 1,
wherein the strength weakened portion is narrowed.

7. A column shifter according to claim 1,
wherein the strength weakened portion is holed through the bellcrank.
